(19) United States
(12) Patent Application Publication
(10) Pub. No.: US 2009/0285953 A1
(43) Pub. Date: Nov. 19, 2009

(54) APPARATUS AND METHOD FOR BREWING COFFEE, TEA AND ESPRESSO

(76) Inventor: Nikolaos Renieris, Neshanic Station, NJ (US)

Correspondence Address: GREENBERG TRAURIG, LLP, MET LIFE BUILDING, 200 PARK AVENUE, NEW YORK, NY, 10166, US

(21) Appl. No.: 11/610,757

(22) Filed: Dec. 14, 2006

(51) Int. Cl. A23L 1/28; A47J 31/00

(52) U.S. Cl. 426/433; 99/282

(57) ABSTRACT

In one embodiment of the present invention an apparatus for brewing coffee, tea and espresso is provided. In another embodiment of the present invention a method for brewing coffee, tea and espresso is provided. The apparatus and method of the present invention may utilize a “pod” in which the coffee, tea and espresso is disposed for brewing. In one example, a pod of a single diameter may be utilized (i.e., a choice of coffee, tea or espresso may be brewed using appropriate pods of essentially the same diameter). In another example, a single water pressure may be utilized (i.e., a choice of coffee, tea or espresso may be brewed using essentially the same water pressure). In another example, a single water pump may be utilized (i.e., a choice of coffee, tea or espresso may be brewed using the same pump). In another example, a single water temperature may be utilized (i.e., a choice of coffee, tea or espresso may be brewed using essentially the same water temperature).

### FIELD OF THE INVENTION

In one embodiment of the present invention an apparatus for brewing coffee, tea and espresso is provided.

In another embodiment of the present invention a method for brewing coffee, tea and espresso is provided.

The apparatus and method of the present invention may utilize a “pod” in which the coffee, tea and espresso is disposed for brewing.

In one example, a pod of a single diameter may be utilized (i.e., a choice of coffee, tea or espresso may be brewed using appropriate pods of essentially the same diameter).

In another example, a single water pressure may be utilized (i.e., a choice of coffee, tea or espresso may be brewed using essentially the same water pressure).

In another example, a single water pump may be utilized (i.e., a choice of coffee, tea or espresso may be brewed using the same pump).

In another example, a single water temperature may be utilized (i.e., a choice of coffee, tea or espresso may be brewed using essentially the same water temperature).

For the purposes of describing the present invention, the term “pod” is intended to refer to a predominantly paper-based envelope for transporting and brewing coffee, tea or espresso. As used herein, the term pod is to be distinguished from a predominantly plastic-based envelope (or “cartridge”).

### BACKGROUND OF THE INVENTION

As is known in the art, the extraction rate for a brewed beverage (e.g., coffee) depends on the type of maker used as well as the form of the product (e.g., pod, ground coffee, etc.). Other variables having an effect on the extraction rate include: the water temperature, the water pressure, the blend, the grind type, the filter type, the contact time between water and ground, and the density of any pod used (e.g., how much product is in a pod of a given volume).

Various systems for making coffee and/or tea have been patented or have had associated patent applications filed. Examples include the systems described in the following U.S. Patent documents.

U.S. Patent Application Publication 2004/0244599 relates to a multi-function coffee maker and use thereof. More particularly, this application relates to a multi-function coffee maker comprising: a casing, a cover assembly with a brewing room inside, a water reservoir, a water pump, an electric heater, a water distributor assembly, a control valve assembly and a base assembly, wherein said coffee maker further comprises more than one brewing accessory, which may be either an espresso coffee brewing accessory, or a drip coffee brewing accessory, or a tea brewing accessory; said brewing accessories are interchangeable and can be loaded within said brewing room of said cover assembly to form an individual brewing chamber; said water reservoir assembly, water pump, water distributor assembly, control valve assembly and brewing chamber construct the water loop of said coffee maker, water flow of different pressures may be generated within said water loop, and water flow of suitable pressure is provided into said brewing chamber according to the brewing requirements. According to the disclosure, drip coffee, or espresso coffee, hot tea or ice tea may be brewed in the same coffee machine.

U.S. Patent Application Publication 2005/0160918 relates to an apparatus for making brewed coffee and the like. More particularly, this application relates to an apparatus for brewing ground, brewable foodstuffs having a water reservoir, a boiler, and a flow meter all connected in a common fluid path with a pump that produces a fluid pressure in the common fluid path. A pod holder capable of receiving a pod formed of filter material and containing a mass of ground, brewable foodstuffs having a sieved bottom is located so as to receive the metered volume of water from the common fluid path. In turn, an interchangeable or pivotally mounted fluid conduit is positioned to receive fluid passing through the sieved bottom and to convey the fluid into one or more cups. It is stated that a small quantity of a brewed liquid, such as coffee, can be produced in a relatively short brewing period with a pleasing taste profile. It is also stated that the fluid pressure may also be adjusted so as to enhance the creation of a crema layer in a coffee drink.

U.S. Pat. No. 6,786,134 relates to a coffee and tea dispenser. More particularly, this patent relates to a beverage system for brewing a beverage from a beverage material and a source of hot, pressurized water. The beverage system may include a cartridge with the beverage material therein. The cartridge may include a seal positioned about the beverage material. The beverage system also may include an injection system for injecting the hot, pressurized water into the cartridge so as to brew the beverage from the beverage material.

U.S. Pat. No. 6,948,420 relates to a coffee and tea pod. More particularly, this patent relates to a container for holding ground coffee or tealeaves. The container may include a body and a lip extending from the body. The lip may include a top substantially flat surface and a width of no more than about 2.6 millimeters (about 0.1 inch).

Further, it is believed that conventional beverage manufacturers offer pods for espresso, coffee, and tea. Such conventional coffee pods are typically loosely packed in 55 mm, 61 mm, and 65 mm sizes by various manufacturers, and are typically brewed using low to no pressure (drip brewer) dispensers. Such conventional tea pods are typically loosely-packed 55 mm pods (some are available in 61 mm pods) and are typically brewed using drip dispensers. Such conventional espresso is typically packed in 45 mm and 55 mm pods, and is typically brewed using a high pressure dispenser. The weights (generally measured in grams) of all these pods typically vary and are typically unique to each individual item packed by their respective companies to achieve certain profiles in flavor, body, and aroma.

However, it is believed that the industry currently does not offer a conventional 45 mm coffee or tea pod. Further, it is believed that there is not a conventional coffee or tea pod that can be used in a high pressure device to brew coffee or tea.

### BRIEF DESCRIPTION OF THE DRAWINGS

FIG. 1 shows a perspective view of a coffee/tea/espresso brewing apparatus according to an embodiment of the present invention;

FIG. 2 shows a perspective view of another coffee/tea/espresso brewing apparatus according to an embodiment of the present invention;

FIG. 3 shows typical filter paper patterns (the four patterns on the right (from right to left) are crepe, mini-squares, waffle, and pebble); and

FIG. 4 shows a chart of industry grinding standards and specs (the upper part of the chart refers to the CBC (Coffee Brewing Center) historical standards, which were developed as a result of an industry survey in the 1940's; the lower part of the chart is a distillation of current industry standards and reflects a certain adaptation to modem brewing methodology).

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

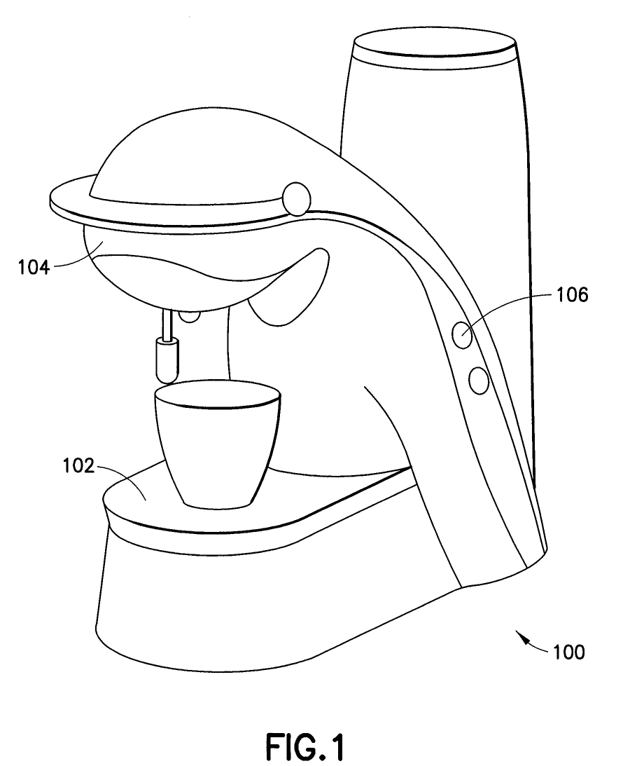

Referring now to FIG. 1, this FIG. shows a perspective view of a coffee/tea/espresso brewing apparatus 100 according to an embodiment of the present invention. Of note, brewing apparatus 100 may include base 102 (upon which a cup may be placed to receive the brewed beverage) as well as pod receiving mechanism 104 (the pod is not shown) disposed above base 102. Various controls 106 may be provided to operate the brewing apparatus 100.

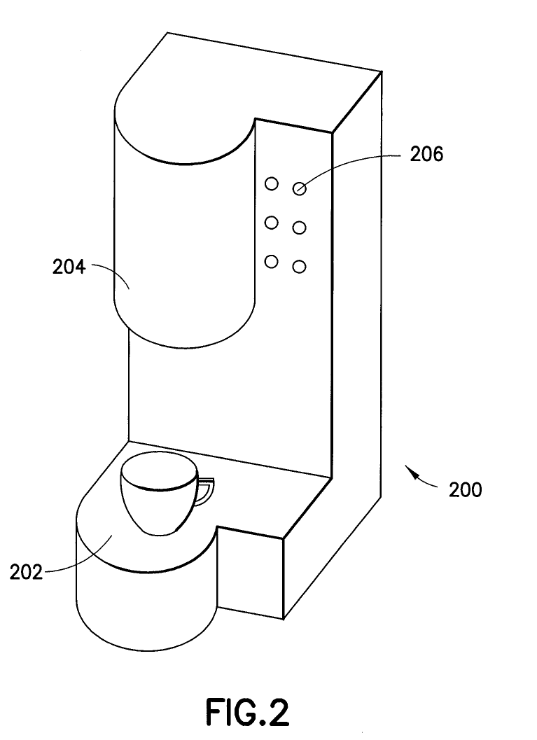

Referring now to FIG. 2, this FIG. shows a perspective view of a coffee/tea/espresso brewing apparatus 200 according to an embodiment of the present invention. Of note, brewing apparatus 200 may include base 202 (upon which a cup may be placed to receive the brewed beverage) as well as pod receiving mechanism 204 (the pod is not shown) disposed above base 202. Various controls 206 may be provided to operate the brewing apparatus 200.

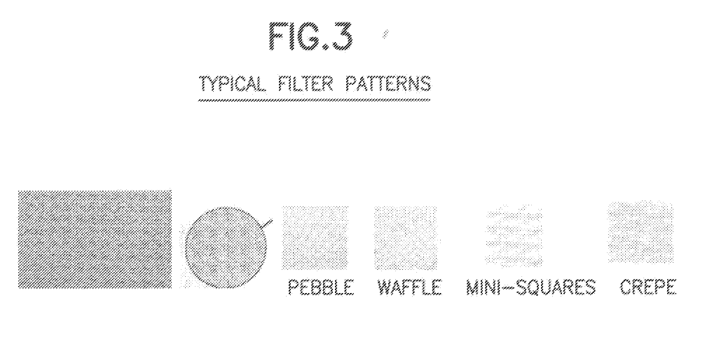

Reference will now be made to pod structure and material according to a specific example of the present invention. Under this example, the pods are made using an oxygen-bleached paper envelope, not the typical waffle weaved or fiber filter material like certain conventional pods. In this regard, conventional waffle weaved filter paper pods are typically bleached with chemicals that compromise the end product—certain elements are extracted from the paper and ultimately end up in the brewed beverage. The paper envelope of this example of the present invention is bleached only with oxygen, not with chemicals or acids. Further, unlike the typical waffle weave filter pod, the paper envelope of this example of the present invention is porous (as evidenced when you hold it up to a light) and free flowing. This allows soluble solids to flow through without extracting (or minimizing extraction of) unwanted particles from the paper. This pass through process is similar to wine, limited to no (or little) filtering for quality extraction. In one example, the weight of the paper may be between 15 lbs and 19 lbs per roll. FIG. 3 shows typical filter paper patterns.

Reference will now be made to an espresso grind according to a specific example of the present invention. Under this example, the espresso is ground to between about 25,000 to 32,000 particles per gram; however, this will vary depending on the beans' origin, roasting temperature, and handling (typical grinds for espresso are 28,000 particles per gram as recommended by the National Italian Espresso Institute).

In another espresso grind according to a specific example of the present invention, blends may come from different regions and varied roasts, and a desired flavor profile may drive the grind specs. Of note, in one specific example of the present invention the pod size may be about 45 mm. This may be a smaller diameter pod, resulting in less volume to pack (relative to the diameter and volume of certain conventional pods). This 45 mm diameter pod may thus be able to achieve a greater density utilizing the same amount of coffee (relative to the diameter and volume of certain conventional pods). Because of this, there may be less surface coverage resistance and tension, leading to better extraction.

Reference will now be made to a tea according to a specific example of the present invention. As is known in the art, teas come in many forms—from granular to a full leaf. Under this example of the present invention the teas are large, broken leaves infused with flowers and other herbs. Further, under this example of the present invention the teas range from all-natural to organic and are not compromised, meaning that the product is not ground to a finer state where it could bruise or burn. Of note, in one specific example of the present invention the pod size may be about 45 mm. This size envelope may keep the tea somewhat restricted (i.e., empty space within the pod is limited). In one specific example of the present invention, by reducing the surface area of the envelope an extraction time under 30 seconds may be achieved (which also can be regulated somewhat with the flow suppression cup). Unlike conventional steeping methods and brewing, the process of this example may reduce the typical brew time of tea by six fold.

Of note, tea has the ability to expand under pressurized hot water. Unlike espresso which essentially doubles in size (100%) to create resistance under the high pressure, tea's expansion is not as pronounced. In order to achieve a similar resistance for tea under one example of the present invention, the envelope size may be reduced (as compared to a conventional size) and the pod may be pre-infused when the machine (i.e., the pod brewer) is initialized, enabling a similar environment as the espresso and creating better extraction.

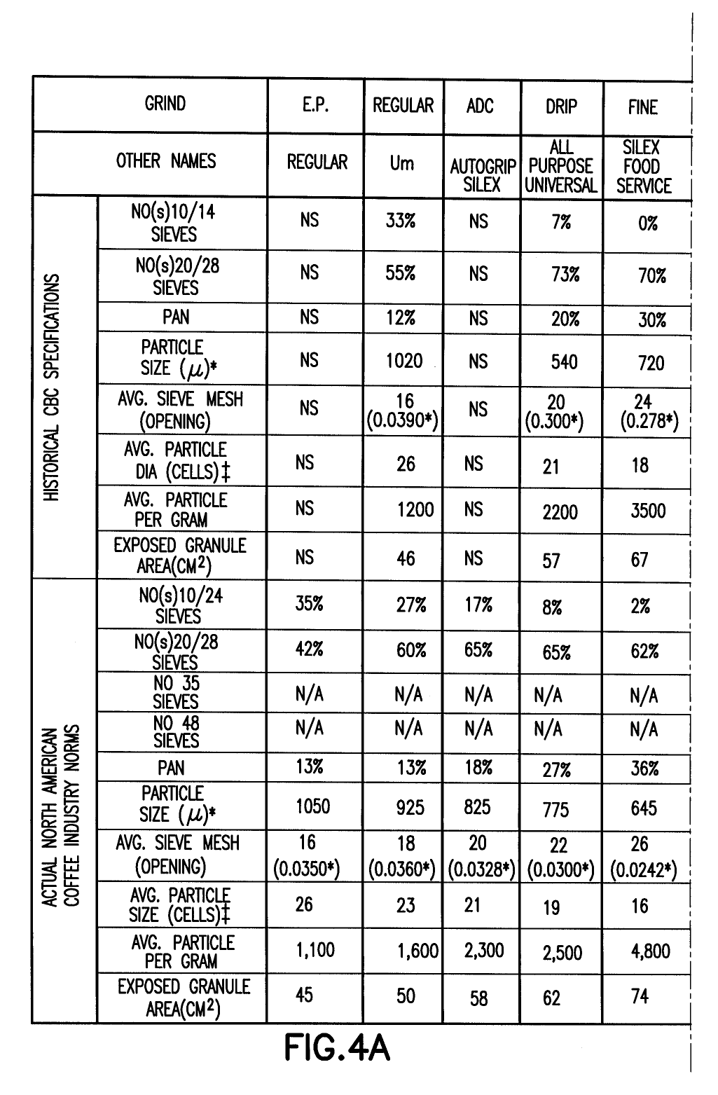

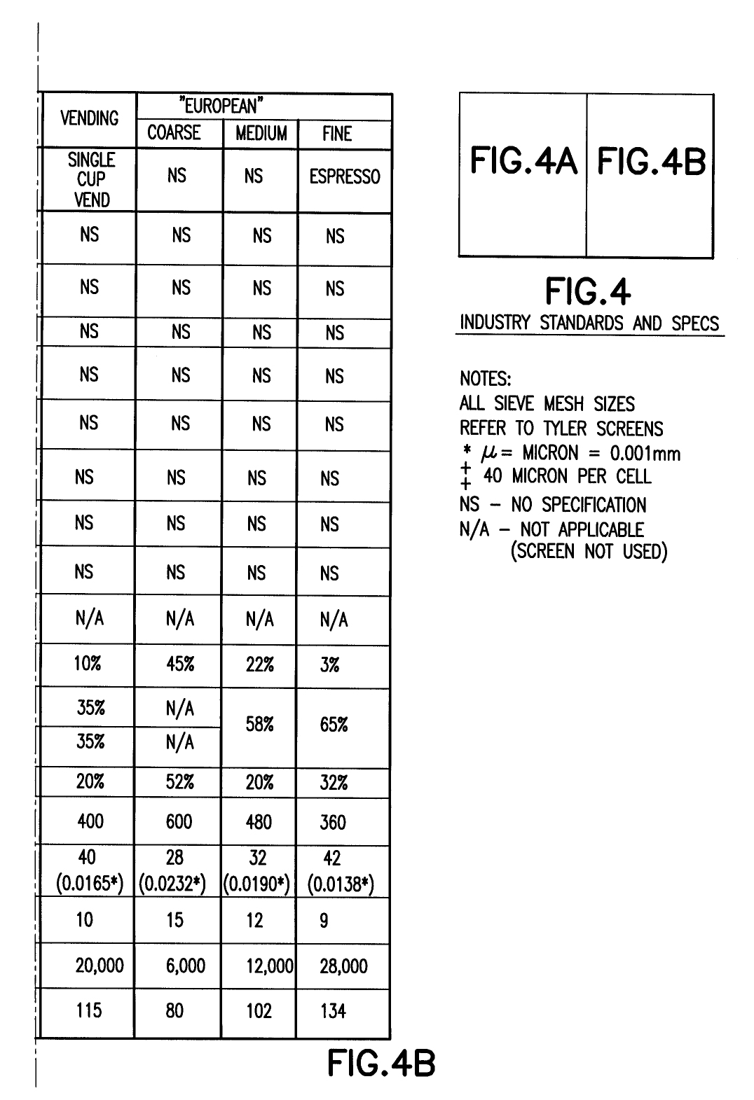

Reference will now be made to a coffee grind according to a specific example of the present invention. As is known in the art, typical grinds for brewed coffee are 2300 particles per gram as specified by MPE-CHICAGO and the SCAA. There are believed to be no specified grinds for pressurized coffee pods (of note, there are believed to be no conventional 45 mm coffee pods). FIG. 4 shows a table of various coffee standards and specs.

The 45 mm coffee pod of one example of the present invention may dispense between 6-7 ounces of coffee through an espresso-type pump machine. A quality extraction through such espresso-type high pressure machines may, under one example of the present invention, be due to the following:

1. Control the grind to between about 18000-22000 particles per gram. This may be done by grinding the beans to a medium-fine grind as opposed to a coarse grind typically used in conventional drip brewer technology.

2. Minimize the back pressure on the ground coffee. Back pressure is created by the coffee's natural ability to essentially double in mass, when it comes in contact with water. By utilizing a smaller surface area (e.g., 45 mm) and adding layers of coffee grounds (the height of the pod in one specific example is approximately 10-12 mm), and using high pressure, the process creates a natural briquette out of the pod which allows the coffee to extract higher soluble parts at faster rates.

Reference will now be made to flow suppression according to a specific example of the present invention. As is known in the art, espresso or pump machines typically incorporate flow suppression devices or cups of some sort. Under this example, a device or cup according to the present invention may provide for a range of 80-160 holes per 46 mm diameter area. Depending on pump style and unit, about 7-11 bars of pressure may be achieved in this example. Espresso, coffee and tea may be brewed as follows: Espresso=9 bars; Coffee=9 bars; Tea=9 bars.

Reference will now be made to pod size according to a specific example of the present invention. Under this example, the pods comprise a 45 mm envelope containing espresso, coffee or tea products. The pods of this example may be packed in weights ranging from 3 g to 8 g. The diameter of all pods in this example is essentially constant (e.g., at 45 mm), but the height and weight of each pod may vary by product:

| PRODUCT | SIZES | WEIGHT | VOLUME/PRODUCT DISPENSED |
|---|---|---|---|
| Espresso | 45 mm | 6-8 gr | 30 ml, 45 ml-60 ml |
| Coffee | 45 mm | 7-9 gr | 195 ml, 180 ml-210 ml |
| Tea | 45 mm | 3-5 gr | 195 ml, 180 ml-210 ml |

In the above example, there is a 10 ml to 15 ml loss of water on the pod itself. Therefore, when the settings are preset on a pod brewing device the lost fill is accounted for.

Reference will now be made to temperature, water pressure and extraction times according to a specific example of the present invention:
Temperature of water: 195° to 200° Fahrenheit
Water pressure: 7.5 bars to 12 bars, (e.g., 9 bars)
Extraction time: Not to exceed 30 seconds per 60 ml

Reference will now be made to boilers and pumps which may be utilized in a brewing device according to a specific example of the present invention. Under this example, boilers and/or thermal blocks may be used (the specific set-up depends on size of the machine). For example, a machine may utilize both boilers and thermal blocks. In another example, a machine may utilize two thermal blocks. Most parts may be either standard issue espresso parts and/or a combination thereof. An objective in configuring pod machines is to insure appropriate pump pressure. Example manufacturers of three specific pumps which may be used are: FLUID-TEC, ULKA and ENCO. A more specific example is the pump manufactured by ULKA S.r.L.-Italy (model E Type EX4, 120 v-60 Hz, 1/1 min C1.A.41 w, water temp max 25° Celsius). Of note, certain inferior pumps may fail when the water temperature increases and becomes gaseous. Since the specific gravity of water decreases as temperature increases, inferior pumps may not accurately dispense.

As discussed above, in one embodiment of the present invention an apparatus and a method for preparing coffee, tea or espresso from the same size pod, utilizing essentially the same pressure and essentially the same temperature for extraction is provided.

In another embodiment of the present invention an apparatus for brewing a beverage is provided, comprising: a pod receiving mechanism, wherein the pod receiving mechanism is sized to receive pods of essentially a single diameter; and a single water pump providing pressurized water at essentially a single pressure to the pod received into the pod receiving mechanism in order brew the beverage; wherein the beverage may be any of coffee, tea and espresso. In one example, a single water temperature may be utilized. In another example, the pods may be received one at a time.

In another embodiment of the present invention a method for brewing a beverage is provided, comprising: receiving pods of essentially a single diameter into a pod receiving mechanism of a brewing apparatus; and providing, from a single water pump associated with the brewing apparatus and to the pod received into the pod receiving mechanism, pressurized water at essentially a single pressure in order brew the beverage; wherein the beverage may be any of coffee, tea and espresso. In one example, a single water temperature may be utilized. In another example, the pods may be received one at a time.

In another embodiment of the present invention a method for producing pods is provided, comprising: inserting coffee into a first pod having a diameter of X mm; inserting tea into a second pod having a diameter of Y mm; and inserting espresso into a third pod having a diameter of Z mm; wherein each of X, Y, and Z are essentially the same. In one example, the first pod may have a height of A mm, the second pod may have a height of B mm and the third pod may have a height of C mm, wherein at least one of A, B and C are different. In another example, each of A, B and C may be different.

While a number of embodiments of the present invention have been described, it is understood that these embodiments are illustrative only, and not restrictive, and that many modifications may become apparent to those of ordinary skill in the art. For example (which example is intended to be illustrative and not restrictive), pods may be manufactured utilizing the manufacturing process (incorporated herein by reference) of Automatic Brewers And Coffee Devices, Inc. (see, e.g., http://www.abcd-pods.com/Pages/tech.html). Further, any steps described herein may be carried out in any desired order (and any desired additional steps may be added and/or any desired steps may be deleted).

What is claimed is:

1. An apparatus for brewing a beverage, comprising:
a pod receiving mechanism, wherein each pod contains a beverage to be brewed and wherein the pod receiving mechanism is sized to receive pods of essentially a single diameter; and
a single water pump providing pressurized water at essentially a single pressure to each of the pods received into the pod receiving mechanism in order to brew the beverage;
wherein the beverage is selected from the group consisting of: coffee, tea and espresso.

2. The apparatus of claim 1, wherein each of the pods are received into the pod receiving mechanism one at a time.

3. The apparatus of claim 1, wherein the single diameter is essentially 45 mm.

4. The apparatus of claim 1, wherein the single water pressure is between about 7.5 bars and about 12 bars.

5. The apparatus of claim 4, wherein the single water pressure is about 9 bars.

6. The apparatus of claim 1, wherein a single water temperature is utilized to brew coffee, tea and espresso.

7. The apparatus of claim 6, wherein the single water temperature is between about 195 degrees Fahrenheit and about 200 degrees Fahrenheit.

8. The apparatus of claim 1, wherein the beverage is brewed in a time not exceeding about 30 seconds per 60 ml of brewed beverage.

9. A method for brewing a beverage, comprising:
receiving pods of essentially a single diameter into a pod receiving mechanism of a brewing apparatus, wherein each pod contains a beverage to be brewed; and
providing, from a single water pump associated with the brewing apparatus and to each of the pods received into the pod receiving mechanism, pressurized water at essentially a single pressure in order to brew the beverage;
wherein the beverage is selected from the group consisting of: coffee, tea and espresso.

10. The method of claim 9, wherein each of the pods are received into the pod receiving mechanism one at a time.

11. The method of claim 9, wherein the single diameter is essentially 45 mm.

12. The method of claim 9, wherein the single water pressure is between about 7.5 bars and about 12 bars.

13. The method of claim 12, wherein the single water pressure is about 9 bars.

14. The method of claim 9, wherein a single water temperature is utilized to brew coffee, tea and espresso.

15. The method of claim 14, wherein the single water temperature is between about 195 degrees Fahrenheit and about 200 degrees Fahrenheit.

16. The method of claim 9, wherein the beverage is brewed in a time not exceeding about 30 seconds per 60 ml of brewed beverage.

17. A method for producing pods, comprising:
inserting coffee into a first pod having a diameter of X mm;
inserting tea into a second pod having a diameter of Y mm; and
inserting espresso into a third pod having a diameter of Z mm;
wherein each of X, Y, and Z are essentially the same.

18. The method of claim 17, wherein:
the first pod has a volume of A ml, the second pod has a volume of B ml and the third pod has a volume of C ml; and
wherein at least one of A, B and C are different.

19. The method of claim 18, wherein A and B are essentially the same and C is different from both A and B.

20. The method of claim 17, wherein a weight of coffee in a pod containing coffee is between about 7 grams and about 9 grams.

21. The apparatus of claim 17, wherein a weight of tea in a pod containing tea is between about 3 grams and about 5 grams.

22. The apparatus of claim 17, wherein a weight of espresso in a pod containing espresso is between about 6 grams and about 8 grams.
